(19) United States
(12) Patent Application Publication
(10) Pub. No.: US 2007/0007068 A1
(43) Pub. Date: Jan. 11, 2007

(54) Sensor system for a crush protection device

(76) Inventors: Thomas Weingaertner, Memmelsdorf (DE); Carsten Abert, Hassfurt (DE)

Correspondence Address: Jacob Eisenberg, Seerainstrasse 3a, Steckborn, CH-8266, CH

(21) Appl. No.: 11/474,507

(22) Filed: Jun. 26, 2006

(30) Foreign Application Priority Data
Jul. 6, 2005 (DE) 20 2005 011 044.2

(51) Int. Cl. B60K 28/10

(52) U.S. Cl. 180/274

(57) ABSTRACT

A sensor system for a crush protection device is disclosed. The system monitors an agitation of a vehicle part with a sensor. The sensor is arranged to detect an object being crushed between an active vehicle part and a body section or another vehicle part. The sensor has a layered formation. The sensor is applied on the active vehicle part and either or both of the body section of the vehicle and the additional vehicle part. Additionally, the sensor is adjusted to the shape of the active vehicle part and either or both of the body section and the additional vehicle part.

### CROSS REFERENCE TO RELATED APPLICATIONS

The present application claims priority to German patent application 20 2005 011 044.2 filed Jul. 6, 2004 which is herein incorporated by reference.

### BACKGROUND OF THE INVENTION

The present invention is directed to a sensor system for a crush protection device of a vehicle.

Known sensor systems for crush protection devices at vehicles, particularly motor vehicles, are formed as contact banks, ultrasonic barriers or infrared barriers. The sensor systems as safety devices cooperate with the crush protection device so as to detect, for example, an object crushed between a vehicle part. The part may be for example a closing window pane and a body section. The cooperation is intended to stop the closing of the window pane and therefore prevent damage to the object, the window pane or the window lifter moving the window pane. Furthermore, touch sensors, for example piezoelectric or pyroelectric sensors, are used as sensors for crush protection devices. The piezoelectric of pyroelectric sensors may beset out as pressure sensors and in particular heat detectors so as to react to exercised pressure and in particular heat.

### SUMMARY OF THE INVENTION

An object of the present invention is to provide a sensor system for a crush protection device for the monitoring of a movement of a vehicle part such that a crushed object is safely detected. A further object is for the sensor system to be produced in a simple and cost-efficient way.

These and other objects are solved by the present invention which provides a sensor system with the characteristics of claim 1.

According to the invention, the sensor of a sensor system is formed layered, applied on an active vehicle part, body section and/or additional vehicle part, and is adjusted to the shape of the active vehicle part, the body section and/or the additional vehicle part.

The solution according to the invention therefore provides a sensor system for a crush protection device for the monitoring of the movement of a vehicle part. The sensor, of the sensor system, is arranged layer-shaped on the active vehicle part itself, the body section of a motor vehicle and/or an additional vehicle part. Accordingly, the sensor and therefore the sensor system are adjusted to the shape of their environment in such a way that they are unobtrusive from the outside and by its layer-shaped and shape-adjusted application cannot be recognized from the outside as a special component. The sensor is connected with the active vehicle part, the body section or the additional vehicle part in such a way that there are no special fixtures, as for example screw or plug connections, openings, indentations, recesses or such, Accordingly, the assembly work for applying the sensor is considerably reduced. A sensor is produced accordingly which, by way of its application, can be extended to areas of vehicles where the application of a sensor has so far been difficult or even impossible.

In an embodiment of the present invention, the sensor is produced by a layer-shaped precipitation on the active vehicle part, the body section of a motor vehicle or the additional vehicle part. Thin layers, which cover the active vehicle part, the body section or the additional vehicle part at least partially, can be produced by the precipitation, by using suitable materials, and based by way of the layer-shaped application to adapt to the shaping of the surface of the active vehicle part, the body section or the additional vehicle part. The thin layers are further firmly connected with the body section or the vehicle part.

The sensor can be arranged on the active vehicle part as well as on the body section or the additional vehicle part. The additional vehicle part can thereby be applied at the vehicle in another function and additionally serve as a carrier medium for the sensor. The sensor may be precipitated from a sealing element forming the additional vehicle part or paneling element allocated to the body. By the application of such a vehicle part, the handling of a big body part for the production of the sensor can be eliminated and the process necessary for the application of the sensor facilitated. The body part serving as a carrier medium can be fixated at the body together with the sensor allocated on the vehicle part and, according to use and kind of the part of the vehicle, glued, plugged, screwed or connected in a different way with the vehicle.

The sensor system may be installed in such a way that that it already recognizes the approaching of an object to the active vehicle part, the body section or the additional vehicle part so as to timely avoid a possible crushing of an object. For this purpose, the sensor may be provided as layered precipitated antennas on the active vehicle part, the body section or the additional vehicle part, which are part of a sensor system and detect an approaching object.

In another embodiment, the sensor detects a force of pressure exercised on the body section or one of the vehicle pieces, the force being potentially caused by an object being crushed between the active vehicle part and the body section or the additional vehicle part. Accordingly, the sensor of the sensor system is installed as a piezoelectric sensor which is applied layered on and partially covers the active vehicle part, the body section or the additional vehicle part. The piezoelectric sensor is subject to a force of pressure which is exercised by an object on the sensor. The sensor translates this force into an electrical signal which can be transmitted and evaluated thereby indicating an object.

The piezoelectric sensor may comprise a piezoelectric layer and electrodes at least partially the covering piezoelectric layer. The piezoelectric sensor can be produced by the precipitation of suitable piezoelectric materials on the active vehicle part, the body section or the additional vehicle part. Tension, in a vertical direction towards the surface, is produced by the piezoelectric layer while being subject to a force of pressure vertical to the surface of the layer which can be measured by electrodes below and above the layer and induce a charge transfer and therefore an electrical signal. The piezoelectric sensor is formed with thin layers produced by precipitation. Accordingly, the piezoelectric sensor is almost invisible from the outside and does not disturb the visual design of the vehicle. Therefore, there are no special measurements necessary for the application of the sensor at the vehicle and the design and set-up of the body do not need to be modified.

The piezoelectric layer of the sensor is at least partially covered with electrodes made from a conductive material, while using a sensor system with a piezoelectric sensor. Because the body normally comprises a metal and therefore a conductive material, it is possible to use the body section as one of the electrodes of the sensor and to apply the piezoelectric layer directly on to the conductive body. Similarly, the vehicle body, if it is conductive and if the sensor is applied on the vehicle part, can be used as an electrode for the sensor. It is an advantage of this embodiment that supply lines for the sensor could be omitted. In a further embodiment, it is also possible to separate the sensor by an isolating layer or be electrically isolated from the body section and to provide electrodes on both sides of the piezoelectric layer so that no electrodes lie on the mass potential of the body or the vehicle part by force.

Additionally, the supply lines necessary for bonding with the sensor can be produced by applying suitable conductive materials on the body section or the vehicle section so as to avoid cables and to simplify the installation and assembly of the sensor and the crush protection device.

It is possible that the electronic selection circuit necessary for the sensor is also produced directly on the active vehicle part, the body section or the additional vehicle part by precipitation of suitable materials together with the piezoelectric sensor. An additional simplification of the construction of the sensor can be reached, short line lengths can be produced between the piezoelectric sensor and the selection switch, and interferences can therefore be minimized.

The sensor of the sensor system can be arranged on or below the coat of lacquer, as for example a seal. By a coat of lacquer covering the sensor, the sensor can be adjusted in colour with the environment to make the piezoelectric sensor invisible from the exterior.

Furthermore, components, such as a sealing, can be arranged to fully or partially cover the sensor, at the body, without aggravating or influencing the components by the piezoelectric sensor. Additionally, the components need not be adjusted to the piezoelectric sensor in its structural shape.

The sensor of the sensor system can, on the one hand, cover a large-surfaced body section so as to detect a possible crush risk in a large area by a single sensor. On the other hand, several small-surfaced sensors can also be arranged on the active vehicle part, the body section or the additional vehicle part, which are spatially offset and therefore receive a spatially differentiated signal. The position of the pressure and therefore the possible crushing can be determined by such a sensor arrangement; and dependant from the determined position, different measurements can be taken. If the sensors are set out as piezoelectric sensors, the small-surfaced sensors have the additional advantage that the parasitic capacitance of a sensor, which is conditional on the piezoelectric layer covered with electrodes, can be kept to a minimum.

In another embodiment, the sensor system is part of a crush protection device for a window pane in a motor vehicle door thereby forming an active vehicle part. The sensor can be installed at a door frame of the motor vehicle door forming the body section or, in case of a door without frame, at a stationary body section of the vehicle body bordering the door opening. The sensor is thereby facing the closing window pane and is installed in an area which picks the active window pane up so that an object which is crushed between the window pane and the door frame, and in particular the body section of the vehicle body during the closing process of the window pane, is detected. It is also possible that the sensor is formed directly on the window pane, such as in the area of the upper window edge.

### BRIEF DESCRIPTION OF THE SEVERAL VIEWS OF THE DRAWINGS

The present invention will be described in more detail below with reference to the appended figures, wherein:

FIG. 1 depicts a side view of a motor vehicle door with a large-surfaced sensor applied at the door frame for a crush protection device;

FIG. 2 depicts a side view of a motor vehicle door with several sensors applied at the door frame;

FIG. 3 depicts a sectional view diagonal to the door frame with a piezoelectric sensor applied on the door frame; and

FIG. 4 depicts a sectional view of a piezoelectric sensor.

### DETAILED DESCRIPTION OF THE INVENTION

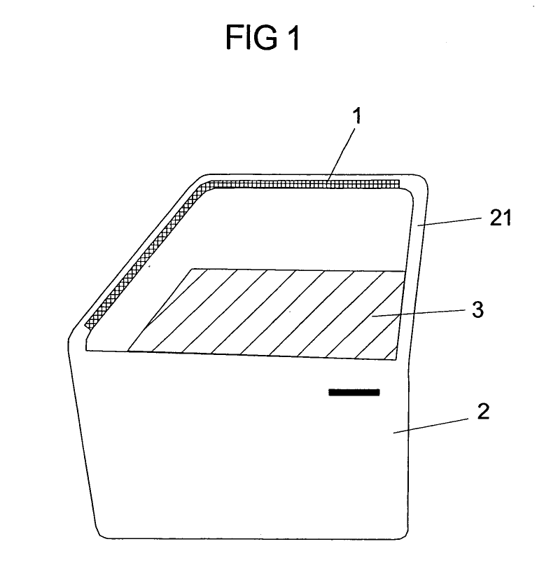

FIG. 1 depicts a side view of a vehicle door 2 with a door frame 21 together forming a body section. The body section may be for the reception of the window pane 3 and further forming the active vehicle part where a sensor 1 may be applied. The sensor may cover the upper part of the door frame 21 on the side facing the window pane 3. The sensor 1 is part of a sensor system of a crash protection device which serves as a security device for a moving of the window pane 3 and for the preventing of a closing whenever an object is detected between window pane 3 and door frame 21 and there is a risk that the object is crushed. The sensor 1 is applied on the closing window 3 facing the door frame 21 and covers the door frame 21. The covering may be in areas where a crushing of an object is possible. If an object is between the window pane 3 and the door frame 21, during the closing of a window pane 3, and the object is crushed between them, then the object, at usage of a pressure-sensitive sensor, exercises pressure on the sensor, and the sensor 1 produces a signal and transmits the signal to a trigger circuit of the crush protection device. The trigger circuit evaluates the signal and prevents the closing process of the window pane 3.

The sensor 1 is applied on the door frame 21 and is adjusted to the shape of the door frame 21. The sensor can be additionally covered by a layer of lacquer and therefore become invisible to the casual eye. The supply lines of the sensor 1 are applied so as to also be substantially invisible from the outside. Alternatively, the supply lines can be produced on the door frame 21 by precipitation of conducting material.

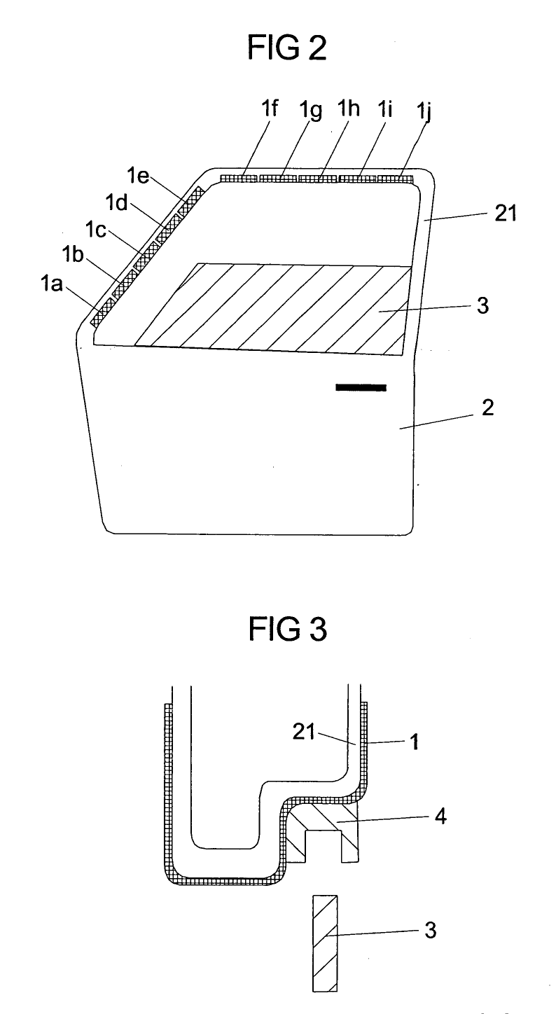

FIG. 2 depicts a side view of a vehicle door 2 with several sensors 1a-1j, spatially offset with respect to the door frame 21. The several sensors cover one another at relatively small sectional areas of the door frame 21. The sensors 1a-1j are connected by supply lines with the trigger circuit of the crush protection device. The crush protection device evaluated the signals of the individual sensors 1a-1j and started the suitable measurements depending upon the signals. For example, it is possible that, sooner or later, the trigger circuit prevents or decelerates the closing process in dependence of the position of the signal-giving sensors 1a-1j. An arrangement according to FIG. 3 is connected with a higher integration expense and a more complex trigger circuit. However, the arrangement can be produced in a relatively simple way, with minimized assembly expense, by successive precipitating steps of suitable material and the automated application of the sensors 1a-1j together with their supply lines.

FIG. 3 depicts a cross section of a door frame 21 with a sensor 1 applied thereon. The sensor 1 comprises a thin layer as arranged on the door frame 21 and is partially covered by a seal 4 for the sealing of the window pane 3 when in a closed position. The sensor 1 is firmly connected with the door frame 21 and conformal to its contour. The sensor can therefore also be produced on curved body sections with complex shapes. If an object is crushed between the window pane 3 and the door frame 21, then, at usage of a pressure-sensitive sensor, pressure is exercised on the sensor 1 at a location or in an area of the door frame 21, a signal of the sensor 1 is produced and the closing process is interrupted. The crush protection device can also be set out in such a way that an object which only lightly touches the sensor 1, or only approaches the sensor, interrupts the closing process of the window pane 3 so as to cause a timely reaction with respect to the risk of a possible crushing. Additional to the pressure-sensitive sensors, touch sensors or space-sensitive sensors, for example near field radar systems, whose antennas are applied conformal on the surface of the door frame as patch antennas and as shown in FIG. 3, can be used for this purpose.

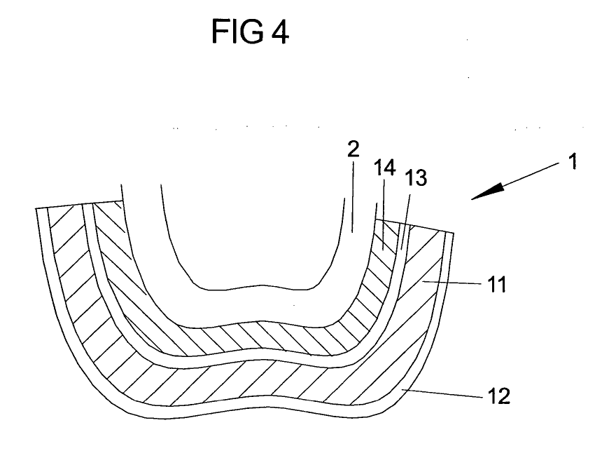

Preferably, the sensor 1 is set out as a pressure-sensitive piezoelectric sensor. FIG. 4 depicts a sectional view of a piezoelectric sensor 1 which comprises a piezoelectric layer 11 and two electrodes 12, 13 and is formed as a pressure sensor in the form of a pressure sensitive layer. The piezoelectric sensor 1 is applied onto the body 2 of a vehicle and separated by an isolating layer 14 from the body 2.

Familiar piezo ceramic materials can be used for the production of the piezoelectric sensors 1, which are applied layer-wise by precipitation on the body 2. The piezoelectric layer 11 is thereby covered on both sides, at least partially, with electrodes 12 and 13. An electrode 13, facing the body, is first produced for application of the sensor on an isolating layer 14. The piezoelectric layer 11 is precipitated on the electrode 13 and then the second electrode 12 is produced on the piezoelectric layer 11. Because of the production in layers, the piezoelectric sensor 1 is adjusted in its shaping to the body 2, is firmly connected to the body 2 and covers the body 2 uniformly.

Because the body 2 of the vehicle normally comprises metal, it is conductive and the lower electrode 13 can be formed by the body 2. The isolating layer 14 and the electrode 13 facing the body can then be omitted and the piezoelectric layer 11 formed directly on the body 2 and connected with it. In this case, the electrode formed by the body 2 is electrically on a mass potential.

To design the piezoelectric sensor 1 as unobtrusively as possible from the outside, the sensor can be covered with a layer of lacquer and therefore adjusted, by way of color, to the body 2 without impairing the operability of the sensor 1.

During the exercising of pressure from the outside, i.e. from the side opposite to the body 2, to the layer-wise piezoelectric sensor 1, a tension is produced by the layer 11, which causes a charge transfer and therefore a signal to the electrodes 12, 13 covering the piezoelectric layer 11 on both sides of which is further processed and evaluated by the trigger circuit of the crush protection device.

The present invention includes other embodiments. For example, additional to the piezoelectric sensor systems, space sensitive sensors like near field radar systems are possible. The systems may have antennas which are precipitated directly onto the body or body part. Furthermore, crash protection systems are also possible for other vehicle parts. Such systems may, for example, be in the area of a vehicle door or the rear flap for the monitoring of the door closing travel, The present inventive concept can be carried over to a lot of possible applications, especially regarding motor vehicles, where sensors adjusted to the surface contour of the vehicle and applied layered-wise on the body or on parts of a vehicle, can be set up.

1. A sensor system of a crush protection device for the monitoring of an active vehicle part, comprising:
a sensor arranged to detect an object crushed between the active vehicle part, a vehicle body section or another vehicle part, wherein the sensor
is formed layered,
is applied on at least one of the active vehicle part, the body section of the vehicle and an additional vehicle part, and
is adjusted to a shape of at least one of the active vehicle part, the body section and the additional vehicle part.

2. The sensor system according to claim 1, wherein sensor borders are arranged to form-fit to at least one of the active vehicle part, the body section of the vehicle and the additional vehicle part.

3. The sensor system according to claim 2, wherein the sensor comprises a substantially identical shape to at least a portion of at least one of the active vehicle part, the body section of the vehicle and the additional vehicle part.

4. The sensor system according to claim 3, wherein the sensor comprises a layered precipitation.

5. The sensor system according to claim 4, wherein the sensor is applied layered on the additional vehicle part forming a carrier means, and the further vehicle part is applied at the vehicle body.

6. The sensor system according to claim 5, wherein the carrier means is attached together with the sensor and applied to the carrier means at the vehicle.

7. The sensor system according to claim 1, wherein the sensor is arranged to detect an approach of an object and recognize a possible crushing of the object.

8. The sensor system according to claim 1, wherein the sensor is arranged to detect an exercised touch, such as a pressure on at least one of the active vehicle part, the body section and the further vehicle part.

9. The sensor system according to claim 8, wherein the sensor is arranged to detect a pressure which is exercised by an object crushed between the active vehicle part and the body section and the sensor is further arranged to generate an electrical signal in response to the pressure.

10. The sensor system according to claim 9, wherein the sensor is a piezoelectric sensor.

11. The sensor system according to claim 10, wherein the sensor comprises a piezoelectric layer and one electrode at least partially covering the piezoelectric layer.

12. The sensor system according to claim 10, wherein at least one of the body section and one of the vehicle parts comprise a further electrode of the sensor and the piezoelectric layer is applied without interlayer directly onto at least one of the active vehicle part, the body section and the further vehicle part.

13. The sensor system according to claim 10, wherein the sensor is applied on an isolating layer which covers at least one of the active vehicle part, the body section and the further vehicle part and further galvanically separates the sensor from at least one of the active vehicle part, the body section and the further vehicle part.

14. The sensor system according to claim 1, wherein supply lines of the sensor comprise precipitation of conductive materials on at least one of the active vehicle part, the body section and the further vehicle part.

15. The sensor system according to claim 1, wherein the sensor is arranged, together with an electronic trigger circuit, on at least one of the active vehicle part, the body section and the further vehicle part.

16. The sensor system according to claim 1, wherein the sensor is arranged above or below a layer of lacquer or under components.

17. The sensor system according to claim 16, wherein the sensor is covered by a layer of lacquer and is unobtrusive from the outside.

18. The sensor system according to claim 1, wherein the sensor comprises several distributed sensors offset and spatially arranged on at least one of the active vehicle part, the body section and the further vehicle part.

19. The sensor system according to claim 1, wherein the sensor is arranged on a door frame of the body section to detect an object crushed between the door frame and a window pane.

20. The sensor system according to claim 1, wherein the sensor is arranged on a body section bordering the door opening to detect an object crushed between the body section and the window pane.
